(19) United States
(12) Patent Application Publication
(10) Pub. No.: US 2023/0063614 A1
(43) Pub. Date: Mar. 2, 2023

(54) DECISION SUPPORT METHOD AND SYSTEM BASED ON GRAPH DATABASE

(71) Applicant: GoGreat CO., LTD., Seoul (KR)

(72) Inventor: JaeSung LEE, Gimpo-si (KR)

(21) Appl. No.: 17/892,049

(22) Filed: Aug. 19, 2022

(30) Foreign Application Priority Data
Aug. 25, 2021 (KR) 10-2021-0112049

(51) Int. Cl. G06Q 10/06; G06F 16/901

(52) U.S. Cl. CPC G06Q 10/0637; G06Q 10/067; G06F 16/9024

(57) ABSTRACT

The disclosure discloses a decision support method. More specifically, it relates to a decision support method and system based on a graph database that supports decision-making so that a manager can easily recognize and understand the results derived by the artificial intelligence system. The disclosure stores a data area practically helpful for decision-making in a graph database for a result derived through an artificial intelligence system, adds a part that can be analyzed and human intervention to overcome the limitations of artificial intelligence, and significantly contribute to controllable automation.

### CROSS-REFERENCE TO RELATED APPLICATION(S)

This application is based on and claims priority under 35 U.S.C. § 119 to Korean Patent Application No. 10-2021-0112049, filed on Aug. 25, 2021, in the Korean Intellectual Property Office, the disclosure of which is incorporated by reference herein in its entirety.

### TECHNICAL FIELD

The disclosure relates to a decision support method and system. It more specifically relates to a decision support method and system based on a graph database for supporting decision-making. If so, a manager may easily recognize and understand a result derived from an artificial intelligence system.

### DISCUSSION OF RELATED ART

A trial and error method is applied to solve various problems, but this method has its limitations because it is a method that requires access to a large number of cases. Artificial intelligence systems are making a significant contribution to overcoming those limitations.

The artificial intelligence system has the characteristic of continuously improving accuracy as the amount of high-quality learning data increases. Still, the results are complicated for humans to understand and difficult to control. In the decision-making stage, it isn't easy to use it as a basis for the actual determination.

To solve this problem, it is possible to trace the path through which the result was derived, like navigation, by creating a step-by-step node and relation diagram for each result derived through the artificial intelligence system.

Meanwhile, with the recent development of measurement and storage technology, it is possible to store various types of data that were not previously of interest in the form of high-resolution graphs, and analysis technology for obtaining new results from these data has been proposed.

Such information and communication technology has caused the development of various data models and data storage management technologies for expressing multiple types of the real world. The technology for visualizing them has also been advanced. As a representative graph data processing solution, there is a graph data type and graph database (GraphDB) technology to deal with complex relations between data objects.

In contrast to the traditional relational database, which stores each object according to a predefined schema structure, GraphDB technology stores each data as a single node and maintains the correlation between nodes while maintaining the properties of all nodes. Therefore, it is advantageous for the integrated storage management of structured and unstructured data.

In particular, a high-resolution large-scale data storage technology such as GraphDB is used to quickly aggregate and provide data on an arbitrary scale in large-scale data.

### SUMMARY

The disclosure provides a decision support method and system that uses GraphDB, a commercialized database system, to track the analysis process of the results according to the learning of the artificial intelligence system and systematically express the reasoning process. It intuitively checks whether the corresponding result has been derived and easily understands it.

To address the issues, the decision support method by a decision support system based on a graph database according to an embodiment of the disclosure may comprise steps of: (a) receiving a result according to the analysis of the input data from an artificial intelligence system; (b) classifying the result into N-th (N is a natural number) intermediate product or final product and converting each N-th intermediate product or final product into a plurality of nodes and properties; (c) calculating scores for the plurality of nodes, deriving a relation between nodes according to the calculated scores, and storing the relation in a database together with properties of all nodes; and (d) displaying the nodes, properties, and relations stored in the graph database as graph data.

Step (c) may comprise step (c1), calculating a total score by summing two or more of the frequency of appearance over time of all nodes and property values for properties of the nodes. A weight calculated by the ResultSet Core Value is determined according to the analysis result, the similarity of the relation, the distance between the core value, and an anomaly score having the highest core value.

Step (c1) may comprise step (c11) determining an anomaly score based on a result derived by at least one of the frequencies of appearance, weight, and similarity; and (c12) automatically setting the property value having the highest anomaly score as a property value connecting each node.

The method may further comprise after step (c12), step (c13) re-setting one or more selected nodes, properties, and relations by modifying nodes, properties, and relations of the graph data according to a manager's input.

The method may further comprise after step (c), step (d) setting the property value having the core value, then re-entering the graph data stored in the graph database as learning data into the artificial intelligence system to repeat the procedure.

Further, the decision support system, according to an embodiment of the disclosure, may comprise a user interface API configured to receive an input of a manager's operation and display graph data for decision making; a web application program configured to receive a result of learning from an artificial intelligence system; a back-end application program configured to convert the result into a formation of a plurality of nodes and properties, calculate a correlation between the plurality of nodes as a score and set a relation according to the calculated score; and a database program configured to store converted nodes, properties, and relations as graph data.

Further, the back-end application program may comprise a data classification program configured to classify data included in the input result into nodes and properties; an AI manager configured to interwork with the artificial intelligence system to receive a result or input graph data as learning data into the artificial intelligence system and extract nodes and properties from the result; a score manager configured to identify and extract data for calculating a score for the result data input from the artificial intelligence system; a score calculator configured to calculate scores for a plurality of classified nodes; a graph manager configured to convert and display relations according to the nodes, properties, and scores into graph data defined by a graph database; and a data analysis manager configured to extract graph data from the database program for the manager's analysis.

Further, the score manager may calculate the total score by calculating the frequency of appearance over time of the data values for all nodes and properties of all nodes, a weight calculated by the ResultSet Core Value of each node according to the analysis result, the similarity of the relation, the distance between the core value and an anomaly score, which is the highest value among the properties of the node corresponding to the core value and summing two or more of all calculation results.

Further, the results may be divided into at least one intermediate product derived as learning progress and the final product. The back-end application program may further comprise a statistics manager configured to reflect a change or correction input from the manager to the graph data for the final result.

The disclosure stores a data area practically helpful for decision-making in a graph database for a result derived through an artificial intelligence system. It adds a part that can be analyzed and human intervention to overcome the limitations of artificial intelligence and significantly contributes to controllable automation.

### BRIEF DESCRIPTION OF THE DRAWINGS

A complete appreciation of the disclosure and many of the attendant aspects thereof will be readily obtained as the same becomes better understood by reference to the following detailed description when considered in connection with the accompanying drawings, wherein:

FIG. 1 is a view illustrating a decision support method based on a graph database according to an embodiment of the disclosure;

FIG. 2 is a schematical view illustrating a method for storing an AI analysis result in a graph database in a decision support method based on a graph database according to an embodiment of the disclosure;

FIG. 3 is a view illustrating the structure of a decision support system based on a graph database according to an embodiment of the disclosure;

FIG. 4 is a view illustrating an output form of a graph data of a decision support system based on graph database according to an embodiment of the disclosure; and

FIG. 5 is a view illustrating a method for dividing a final result according to artificial intelligence learning in a minimum number of steps in a decision support method based on a graph database according to an embodiment of the disclosure.

### DETAILED DESCRIPTION OF EXEMPLARY EMBODIMENTS

The disclosure is described in detail with reference to the accompanying drawings and embodiments.

It should be noted that the technical terms used herein only describe specific embodiments and are not intended to limit the disclosure.

Further, the technical terms used herein should be interpreted in a generally understood meaning. They should not be interpreted in an excessively inclusive meaning or an excessively reduced meaning by those of ordinary skill in the art to which the disclosure belongs unless otherwise defined in the disclosure. In addition, when the technical term used in the disclosure is an erroneous technical term that does not accurately express the spirit of the disclosure, it should be replaced with a technical term that can be correctly understood by those skilled in the art. In addition, the general terms used herein should be interpreted as defined in the dictionary or as to the context before and after and should not be interpreted in an excessively reduced meaning.

Further, the singular expression used herein includes the plural expression unless the context dictates otherwise. As used herein, terms such as “consisting of” or “comprising” should not be construed as necessarily including all of the various elements or several steps described in the disclosure. It should be construed that some elements or some steps among them may not be included or additional elements or steps may further be included.

Further, as used herein, terms including ordinal numbers such as first, second, etc., may describe the components, but the terms should not limit the components. The terms are used only to distinguish one component from another. For example, a first component may be referred to as a second component without departing from the scope of the disclosure. Similarly, the second component may also be referred to as the first component.

Hereinafter, the accompanying drawings describe a preferred embodiment according to the disclosure in detail. Still, the same or similar components are assigned the same reference numerals regardless of reference numerals, and the redundant description thereof is excluded.

Further, in the description of the disclosure, if it is determined that a detailed description of a related known technology may obscure the gist of the disclosure, the detailed description thereof is excluded. Further, it should be noted that the accompanying drawings are only for easy understanding of the spirit of the disclosure and should not be construed as limiting the spirit of the disclosure by the accompanying drawings.

In the following description, the ‘decision support system based on graph database’ of the disclosure may be abbreviated as ‘decision support system’ or ‘system’ for convenience of description.

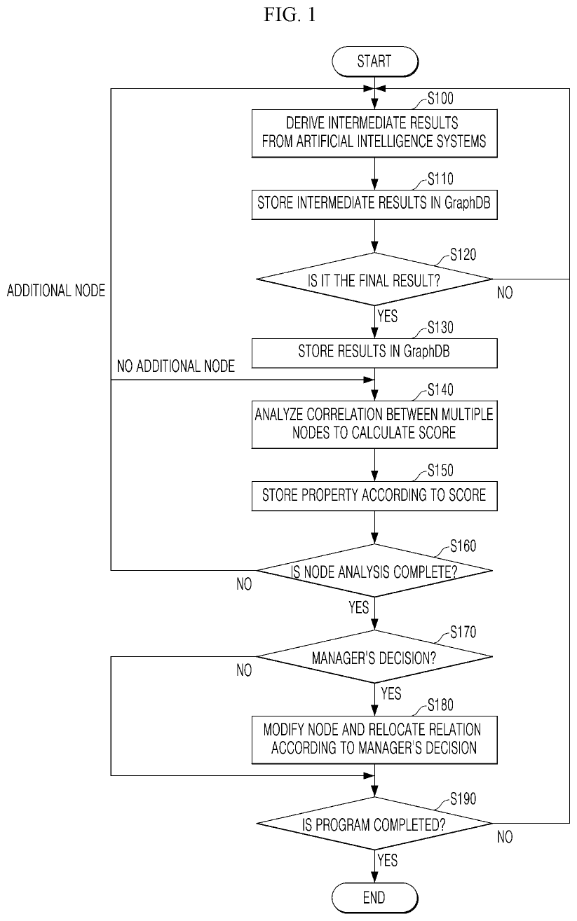

FIG. 1 illustrates a decision support method based on a graph database according to an embodiment of the disclosure. In the following description, the execution entity of each step becomes the decision support system and its constituent parts of the disclosure, even if there is no separate description.

The decision support method based on a graph database according to an embodiment of the disclosure may comprise steps of receiving a result from an artificial intelligence system; (b) classifying the result into N-th (N is a natural number) intermediate product or final product and converting each N-th intermediate product or final product into a plurality of nodes and properties to store the same in the graph database; calculating scores according to a relation between the plurality of nodes and setting and storing a relation according to the calculated scores in the database; and displaying the nodes, properties, and relations stored in the database as graph data.

Hereinafter, FIG. 1 describes the decision support method based on the graph database of the disclosure according to this procedure in detail.

The decision support method based on a graph database according to an embodiment of the disclosure provides a process of deriving a final result in the form of a dynamic graph based on GraphDB for a result of data analyzed through an artificial intelligence system. Accordingly, it provides a technical means by which the manager can easily check the details over time.

The system of the disclosure derives an intermediate result according to analysis from an artificial intelligence system according to a predetermined period (S100), converts the intermediate result into a node and a property, and stores them in a database (S110).

Next, the system determines whether the GraphDB result is the final result (S120), and if not, the steps of deriving and storing the intermediate result again through the artificial intelligence system are repeated (S100, S110). If it is the final result, the nodes and properties for the final result are stored in the database (S130).

Next, the system calculates a score according to the relation between a plurality of nodes stored in the database (S140). At this time, the step of calculating the relation between a plurality of nodes in the GraphDB can be embodied as a process of calculating at least one anomaly core value that represents nodes stored in graph database format, frequency of appearance of data indicated by the properties of the node, core value, which is an important index among each node derived according to the analysis result, a weight of data, similarity between data at the time of analysis of relation through GraphDB, distance from core value, and singularity data score that can represent the relation between nodes, the weight of data, relation through GraphDB analysis time, the similarity between data, the distance from the core value, and the relation between nodes and calculating a total score by summing the calculated values.

The score is a value obtained by quantifying a property designated as anomaly score data as a relation between nodes. It can be interpreted that the higher the score, the higher the relevance between connected nodes. Further, graph data may be generated centering on a node having the highest core value.

In addition, the anomaly data is the property that best reveals the meaning of the data among the properties of the node having the highest core value and may be automatically selected by the system or directly selected by a manager.

Next, the system stores the calculation result as a relation in the database according to the calculated score (S150).

Next, it is determined whether the correlation analysis between the node stored in the database and the existing node is completed (S160). When the analysis is not completed, if there is a to-be-added node from step S100 may be re-performed. When the analysis is not completed, and there is no to-be-added node, from step S140 may be re-performed.

When the node analysis is completed, that is, when the data stored in the database is data about the final result, the manager directly reviews the data stored in the database and proceeds with the procedure according to the decision (S160).

The manager may check each node, property, and relation between nodes through the graph data provided by GraphDB. According to the manager's decision (S170), the system may use or delete some of the nodes or relocate the relation (S180). Alternatively, the current state may be maintained as it is.

Next, the system may check the termination signal of the program by the manager. If the termination signal does not occur, the system returns to step S100 to continue the analysis, and when the termination signal occurs, the system terminates the procedure.

According to the above steps, the analysis results by the artificial intelligence system are sequentially converted into graph data, and the product is stored in the graph database to visualize the artificial intelligence analysis procedure. This allows the manager to easily determine the analysis path of the relevant output and to change and reanalyze it according to his/her intentions.

Hereinafter, the drawings describe the decision support method based on a graph database according to an embodiment of the disclosure.

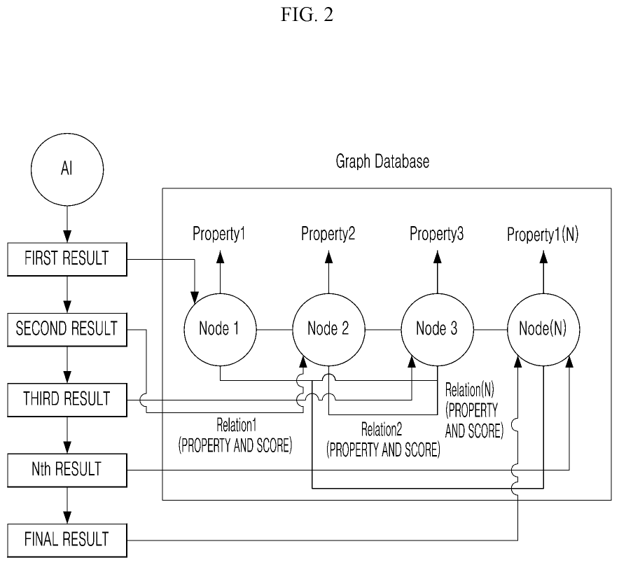

FIG. 2 is a schematical diagram illustrating a method for storing an AI analysis result in a graph database in a decision support method based on a graph database according to an embodiment of the disclosure.

Referring to FIG. 2, a result that is a result analyzed by an artificial intelligence system (AI) may be divided into an N-th (N is a natural number) intermediate result until a final result is reached. Therefore, the decision support system of the disclosure repeatedly converts the result into a GraphDB until it is reached so that intermediate confirmation is possible by the manager. Thus, it may be visualized so the manager can track which analysis path the final product reaches.

The decision support system of the disclosure may extract n nodes constituting graph data and properties thereof from the N-th result output by the artificial intelligence system (AI). The system can divide and store the data extracted from the N-th result in a database based on GraphDB, calculate a score from nodes and properties, and store it as a relation.

According to the N-th result, the system may add at least one node n (n is a natural number), respectively, and the system provides each node for each node among the properties for each node n (Node n). You can display the relation between each other as a score, connect neighboring nodes to each other, and display the score. The system may display the relation between nodes as a score for each node among the properties for each node n and connect neighboring nodes to each other to display the score. As the analysis proceeds from the 1st result to the N-th result by the artificial intelligence system, the result is stored while adding or updating each node and property.

Further, the decision support system of the disclosure may provide the N-th result stored in the database and its change process to the manager's terminal in the form of a graph. The manager may intuitively check which path the N-th result is derived, change the core value according to the intention, or directly input the necessary data to implement an iterative cycle model by re-learning the artificial intelligence system.

Hereinafter, the drawings will describe the decision support system based on the graph database according to an embodiment of the disclosure in detail.

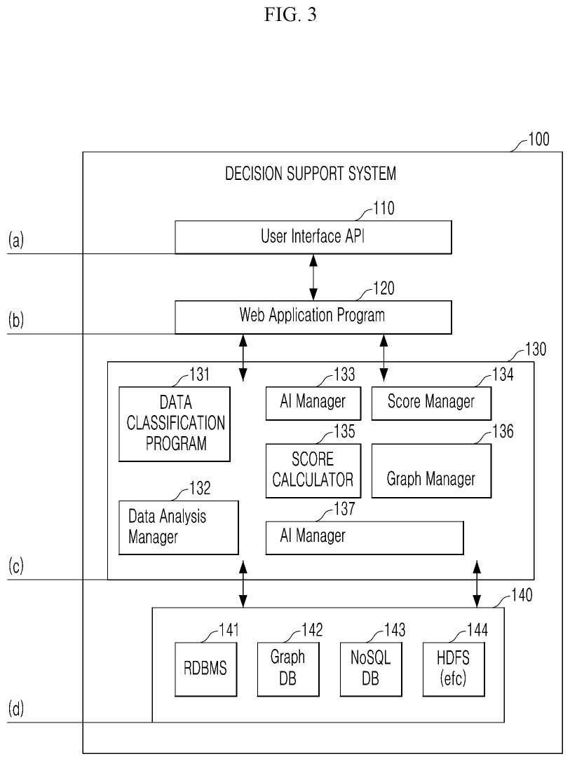

FIG. 3 illustrates the structure of a decision support system based on a graph database according to an embodiment of the disclosure.

Referring to FIG. 3, the decision support system based on a graph database according to an embodiment of the disclosure may comprise a user interface API 110 configured to receive an input of a manager's operation and display graph data for decision making, a web application program 120 configured to receive a result of learning from an artificial intelligence system, a back-end application program 130 configured to convert the result into a formation of a plurality of nodes and properties, calculate a correlation between the plurality of nodes as a score, and set a relation according to the calculated score. A database program 140 is configured to store converted nodes, properties, and relations as graph data.

As shown, the system 100, according to the embodiment of the disclosure be classified into 4 layers of a user interface layer (a), a front-end application layer (b), a back-end application layer (c), and a data layer (d) according to the function of each component.

The user interface layer (a) may comprise the user interface API 110. The user interface API 110 may receive an input from the manager terminal and reflect it in the system 200 or display graph data generated in the back-end application layer (c) on the manager terminal.

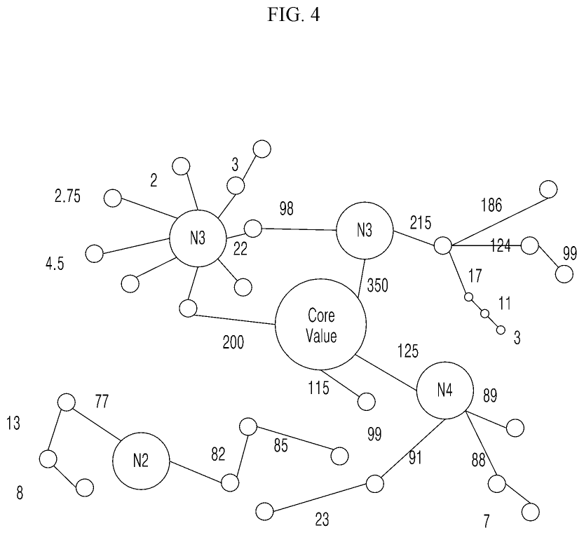

In addition, the user interface API 110 may provide graph data according to the intermediate result and the final result to the manager terminal connected to the system 100 in the form described in FIG. 4 to be described later.

The front-end application program layer (b) may comprise a web application program 120 that provides a web-based screen to the manager terminal. The web-based application program 120 may allow the manager terminal to input web-based data on the web or to check graph data to use the system 100. It may especially show the graph of the result in a form that changes with time through dynamic screen generation.

The back-end application program layer (c) may comprise a plurality of programs that analyze results and generate graph data by the artificial intelligence system. In detail, the back-end application program layer (c) comprises a data classification program 131 for classifying input data, which is an input analysis target, a data analysis manager 132 for analyzing input data, AI manager 133 for detecting an anomaly according to the analysis and calculating an anomaly score, a score calculator 135 for calculating the frequency of appearance of specific data over time, weight of data and similarity of data, a graph manager 136 generating GraphDB-based graph data according to the calculated score, and a statistics manager 137 for reanalyzing the final result by changing or modifying it by a manager intervention according to an input from the manager terminal.

The data layer (d) may comprise a plurality of programs for storing and analyzing input and graph data. In detail, RDBMS 141 is a relational database for storing input data, GraphDB 142 for storing graph data, NoSQL 143 for storing input data non-relationally, and HDFS 144 for storing and processing Hadoop-based large-capacity data.

Data stored in the RDBMS 141, NoSQL 143, HDFS 144, and other data not shown may be stored as graph data of the GraphDB 132 through the back-end application program layer (c). Accordingly, the stored data may be provided in the form of a graph to the manager, who is the final decision maker through the dynamic screen generator provided by the front-end application program layer (b), for example, the web application program 120 over time.

Hereinafter, the drawings describe graph data provided to a decision support system based on a graph database according to an embodiment of the disclosure in detail.

FIG. 4 illustrates an output form of graph data of a decision support system based on a graph database according to an embodiment of the disclosure.

FIG. 4 shows graph data generated by a graph database-based decision support system according to an embodiment of the disclosure. Among the property values of the nodes, any of the highest nodes has a core value as an essential node. A plurality of nodes N1 to N4 directly or indirectly connected to the node having the highest core value may be displayed.

According to repeated learning, the artificial intelligence system automatically finds the core value. Still, according to an embodiment of the disclosure, the manager may intervene in determining the core value.

Other nodes (N1 to N4) may be a set of intermediate results derived by the artificial intelligence system. The system may store a set of these intermediate results as nodes and store the properties of the nodes in the graph database.

The system may express the relation with the intermediate results for the artificial intelligence system to derive the final result based on the core value and the properties as a score.

Further, the system may set any property with a high frequency of appearance among the node properties determined as the core value as anomaly data and display the score as a relation on the graph. Specifically, the system may determine an anomaly score based on a result derived by at least one of the frequency of appearance of data, weight, and similarity. If so, it may automatically set the property value with the highest anomaly score as the property connecting each node.

In particular, either a method in which the system automatically selects one property with the highest value or a method in which a manager directly selects a property may be applied to the property determined by the anomaly data.

For example, suppose it is assumed that the node, which is the core value, is a ‘specific person,’ and among attribute values, and the score according to the anomaly data is the intimacy of the specific person to the people around him/her. In that case, the value of the anomaly score is set as a relation in the center of the core value to easily check the intimacy of a plurality of nodes (N1 to N4) through the scores.

In addition, the correlation between nodes, that is, the nodes (N3, N4) corresponding to the neighbors directly correlated with the ‘specific person’, and the nodes (N1, N2) corresponding to the neighbors having an indirect correlation through others may be understood at a glance.

Further, a small circle other than the nodes N1 to N4 is a lower node, and when there is a large number of data, it may be expressed as a lower node of the N-th (N is a natural number) or higher.

Further, the type and score of the anomaly data derived through the artificial intelligence system may be variably changed depending on the incoming data over time. A manager may also change them, so the system variably generates graph data based on the core value, which may be reflected in the graph.

Hereinafter, the drawings describe a procedure for deriving a final result in a decision support method based graph database according to an embodiment of the disclosure.

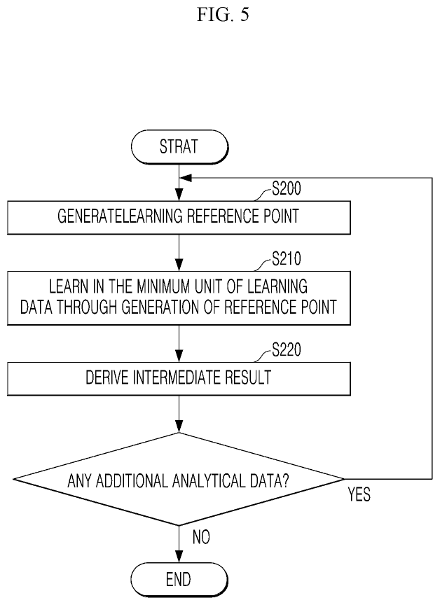

FIG. 5 is a diagram illustrating a method for dividing a final result according to artificial intelligence learning in a minimum number of steps in a decision support method based a on graph database according to an embodiment of the disclosure.

Referring to FIG. 5, for a result output from the artificial intelligence system, the system generates a reference point of the learning data to generate a final result in a minimum unit (S200).

Specifically, to generate the final result in the minimum unit, the intermediate result according to AI learning is input in units of years, months, days, minutes, and seconds according to the amount of data based on time data. When time data does not exist, any one of the representative properties may be used. When the representative of any property is not used, a reference point is created by setting a virtual identifier as a hash value. If so, an intermediate result can be derived as a learning result of the minimum unit (S210).

In this way, the system allows the artificial intelligence system to perform learning with the minimum unit of learning data through reference point generation to derive an intermediate result (S220).

Thereafter, if additional analysis data exists, the system performs steps S200 to S220 above to derive a final result.

Although many matters are specifically described in the above description, these should be construed as examples of preferred embodiments rather than limiting the scope of the disclosure.

Accordingly, the disclosure should not be defined by the described embodiments but should be defined by the claims and equivalents to the claims.

What is claimed is:

1. A decision support method by a decision support system based on a graph database, comprising steps of:
(a) receiving a result according to the analysis of the input data from an artificial intelligence system;
(b) classifying the result into N-th (N is a natural number) intermediate product or final product and converting each N-th intermediate product or final product into a plurality of nodes and properties;
(c) calculating scores for the plurality of nodes, deriving a relation between nodes according to the calculated scores, and storing the relation in a database together with properties of all nodes; and
(d) displaying the nodes, properties, and relations stored in the graph database as graph data.

2. The decision support method of claim 1, wherein step (c) comprises step of
(c1) calculating a total score by summing two or more of the frequency of appearance over time of all nodes and property values for properties of the nodes, a weight calculated by the ResultSet Core Value determined according to the analysis result, the similarity of the relation, the distance between the core value and an anomaly score having the highest core value.

3. The method of claim 2, wherein step (c1) comprises steps of
(c11) determining an anomaly score based on a result derived by at least one of the frequency of appearance, weight, and similarity; and
(c12) automatically setting the property value having the highest anomaly score as a property value connecting each node.

4. The method of claim 3, further comprising, after step (c12),
(c13) re-setting one or more selected nodes, properties, and relations by modifying nodes, properties, and relations of the graph data according to a manager's input.

5. The method of claim 3, further comprising, after step (c),
(d) setting the property value having the core value, then re-entering the graph data stored in the graph database as learning data into the artificial intelligence system to repeat the procedure.

6. A decision support system comprising
a user interface API configured to receive an input of a manager's operation and display graph data for decision making;
a web application program configured to receive a result of learning from an artificial intelligence system;
a back-end application program configured to convert the result into a formation of a plurality of nodes and properties, calculate a correlation between the plurality of nodes as a score, and set a relation according to the calculated score; and
a database program configured to store converted nodes, properties, and relations as graph data.

7. The system of claim 6, wherein the back-end application program comprises
a data classification program configured to classify data included in the input result into nodes and properties;
an AI manager configured to interwork with the artificial intelligence system to receive a result or input graph data as learning data into the artificial intelligence system and extract nodes and properties from the result;
a score manager configured to identify and extract data for calculating a score for the result data input from the artificial intelligence system;
a score calculator configured to calculate scores for a plurality of classified nodes;
a graph manager configured to convert and display relations according to the nodes, properties, and scores into graph data defined by a graph database; and
a data analysis manager configured to extract graph data from the database program for the manager's analysis.

8. The system of claim 7, wherein the score manager calculates the total score by calculating the frequency of appearance over time of the data values for all nodes and properties of all nodes, a weight calculated by the ResultSet Core Value of each node according to the analysis result, the similarity of the relation, the distance between the core value and an anomaly score, which is the highest value among the properties of the node corresponding to the core value and summing two or more of all calculation results.

9. The system of claim 7, wherein the results are divided into at least one intermediate product derived as learning progresses and the final product, and
wherein the back-end application program further comprises a statistics manager configured to reflect a change or correction input from the manager to the graph data for the final result.
